(19) United States
(12) Patent Application Publication
(10) Pub. No.: US 2026/0196778 A1
(43) Pub. Date: Jul. 9, 2026

(54) ELECTRICAL CONNECTOR WITH IMPROVED ANTI-SIGNAL CROSSTALK PERFORMANCE

(71) Applicant: DONGGUAN LUXSHARE TECHNOLOGIES CO., LTD, Dongguan City (CN)

(72) Inventors: Kunlin YAO, Dongguan City (CN); Chenhui ZENG, Dongguan City (CN)

(73) Assignee: DONGGUAN LUXSHARE TECHNOLOGIES CO., LTD, Dongguan City (CN)

(21) Appl. No.: 19/299,059

(22) Filed: Aug. 13, 2025

(30) Foreign Application Priority Data
Jan. 9, 2025 (CN) 202510038718.8

(51) Int. Cl. H01R 13/6585; H01R 13/6461; H01R 13/6591; H01R 13/6593

(52) U.S. Cl. CPC H01R 13/6585; H01R 13/6461; H01R 13/65914; H01R 13/65918; H01R 13/6593

(57) ABSTRACT

An electrical connector includes a body and an installation module. The installation module includes a terminal module, a first ground terminal, a second ground terminal, a first metal shielding piece and a second metal shielding piece. The terminal module includes a first signal terminal, a second signal terminal, and a first insulating block fixed on the first signal terminal and the second signal terminal. The first ground terminal is spaced apart from the first insulating block along a first direction. The second ground terminal is spaced apart from the first insulating block along the first direction. The first metal shielding piece and the second metal shielding piece are in contact with the first ground terminal and the second ground terminal, respectively.

### CROSS-REFERENCE TO RELATED APPLICATION

This patent application claims priority of a Chinese Patent Application No. 202510038718.8, filed on Jan. 9, 2025 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

An electrical connector in related technologies includes a terminal module, a first metal shielding piece located on one side of the terminal module, and a second metal shielding piece located on another side of the terminal module. The terminal module includes a first signal terminal, a second signal terminal, a first ground terminal located on one side of the first signal terminal and the second signal terminal, a second ground terminal located on another side of the first signal terminal and the second signal terminal, and an insulating block molded on the first ground terminal, the first signal terminal, the second signal terminal and the second ground terminal.

In the related art, since the insulating block is at least partially molded on the first ground terminal and the second ground terminal, when the first metal shielding piece and the second metal shielding piece contact the first ground terminal and the second ground terminal, portions of the first ground terminal and the second ground terminal wrapped by the insulating block cannot contact the first metal shielding piece and the second metal shielding piece. Therefore, the anti-signal crosstalk performance of the electrical connectors in the related art still needs to be improved.

### SUMMARY

The present disclosure adopts the following technical solution: an electrical connector, including: a body, the body including a mounting surface; and an installation module, the installation module being mounted to the body, the installation module including: a terminal module, the terminal module including a first signal terminal, a second signal terminal, and a first insulating block fixed on the first signal terminal and the second signal terminal; the first signal terminal including a first fixing portion fixed in the first insulating block and a first contact portion protruding beyond the first insulating block; the second signal terminal including a second fixing portion fixed in the first insulating block and a second contact portion protruding beyond the first insulating block; a first ground terminal, the first ground terminal being spaced apart from the first insulating block along a first direction; the first ground terminal including a first main body portion and a third contact portion; the first main body portion being exposed to the first insulating block along a second direction perpendicular to the first direction; a second ground terminal, the second ground terminal being spaced apart from the first insulating block along the first direction; the second ground terminal including a second main body portion and a fourth contact portion; the second main body portion being exposed to the first insulating block along the second direction; a first metal shielding piece, the first metal shielding piece including a first abutting portion, a second abutting portion, and a first raised portion connecting the first abutting portion and the second abutting portion; the first abutting portion being in contact with the first ground terminal; the second abutting portion being in contact with the second ground terminal; the first raised portion being configured to at least partially accommodate the first insulating block; and a second metal shielding piece, the second metal shielding piece including a third abutting portion, a fourth abutting portion, and a second raised portion connecting the third abutting portion and the fourth abutting portion; the third abutting portion being in contact with the first ground terminal; the fourth abutting portion being in contact with the second ground terminal; the second raised portion being configured to at least partially accommodate the first insulating block; wherein the first contact portion, the second contact portion, the third contact portion and the fourth contact portion all protrude beyond the mounting surface.

The present disclosure also adopts the following technical solution: an electrical connector, including: a body, the body including a mounting surface; and an installation module, the installation module being mounted to the body, the installation module including: a plurality of terminal modules, the plurality of terminal modules being disposed at intervals along a first direction; each terminal module including a first signal terminal, a second signal terminal, and a first insulating block fixed on the first signal terminal and the second signal terminal; the first signal terminal including a first contact portion; the second signal terminal including a second contact portion; a plurality of first ground terminals, each first ground terminal including a first main body portion and a third contact portion; a plurality of second ground terminals, each second ground terminal including a second main body portion and a fourth contact portion; a first metal shielding piece, the first metal shielding piece including a first abutting portion, a second abutting portion, and a first raised portion connecting the first abutting portion and the second abutting portion; the first abutting portion being in contact with the first ground terminal; the second abutting portion being in contact with the second ground terminal; and a second metal shielding piece, the second metal shielding piece including a third abutting portion, a fourth abutting portion, and a second raised portion connecting the third abutting portion and the fourth abutting portion; the third abutting portion being in contact with the first ground terminal; the fourth abutting portion being in contact with the second ground terminal; the first insulating block being clamped by the first raised portion and the second raised portion; wherein two sides of each terminal module along the first direction are associated with one first ground terminal and one second ground terminal; none of the first ground terminal and the second ground terminal is covered by the first insulating block; the first main body portion of the first ground terminal is exposed to the first insulating block along a second direction perpendicular to the first direction, so that the first abutting portion and the third abutting portion are in continuous contact with two opposite sides of the first main body portion, respectively, along the second direction; the second main body portion of the second ground terminal is exposed to the first insulating block along the second direction, so that the second abutting portion and the fourth abutting portion are in continuous contact with two opposite sides of the second main body portion, respectively, along the second direction; wherein the first contact portion, the second contact portion, the third contact portion and the fourth contact portion all protrude beyond the mounting surface.

### BRIEF DESCRIPTION OF DRAWINGS

FIG. 1 is a schematic perspective view of an electrical connector in accordance with an embodiment of the present disclosure;

FIG. 2 is a perspective view of FIG. 1 from another angle;

FIG. 3 is a partial enlarged view of circled part B in FIG. 2;

FIG. 4 is a right view of FIG. 1;

FIG. 5 is a partially exploded perspective view of FIG. 1;

FIG. 6 is a partially exploded perspective view of FIG. 5 from another angle;

FIG. 7 is a further partially exploded perspective view of FIG. 5;

FIG. 8 is a partially exploded perspective view of FIG. 7 from another angle;

FIG. 9 is an exploded perspective view of a bracket and an installation module in FIG. 7 when they are separated from each other;

FIG. 10 is an exploded perspective view of FIG. 9 from another angle;

FIG. 11 is a right view of FIG. 9;

FIG. 12 is a partially exploded perspective view of the installation module in FIG. 9;

FIG. 13 is a partially exploded perspective view of FIG. 12 from another angle;

FIG. 14 is a further partially exploded perspective view of FIG. 12;

FIG. 15 is a partially exploded perspective view of FIG. 14 from another angle;

FIG. 16 is a partially exploded perspective view of a terminal module and a plurality of cables in FIG. 14 when they are separated from each other;

FIG. 17 is a further partially exploded perspective view of FIG. 16;

FIG. 18 is a front view after removing a first insulating block, a first metal shielding piece, a second metal shielding piece and a second insulating block in FIG. 14;

FIG. 19 is a partial enlarged view of frame part C in FIG. 18;

FIG. 20 is a further exploded view of FIG. 18;

FIG. 21 is a schematic cross-sectional view taken along line D-D in FIG. 4;

FIG. 22 is a partial enlarged view of frame part E in FIG. 21; and

FIG. 23 is a schematic cross-sectional view taken along line F-F in FIG. 4.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

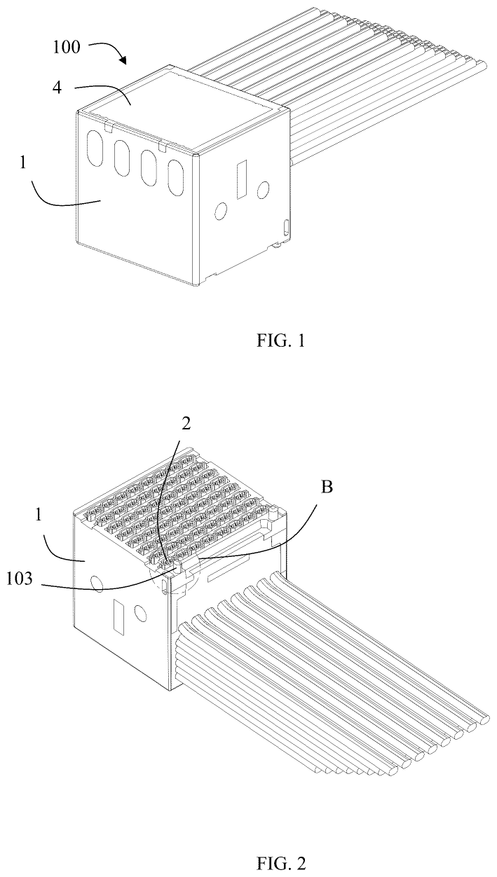

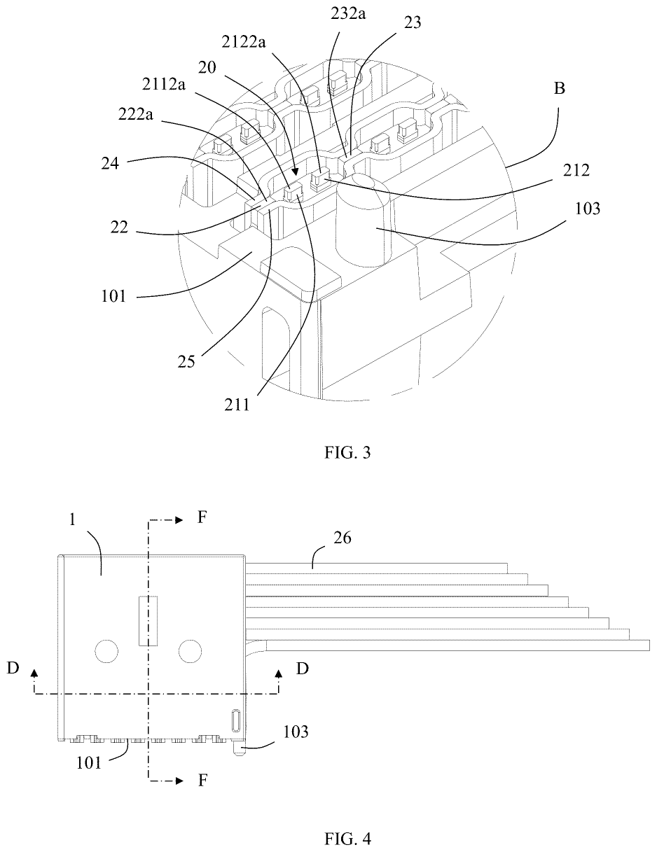

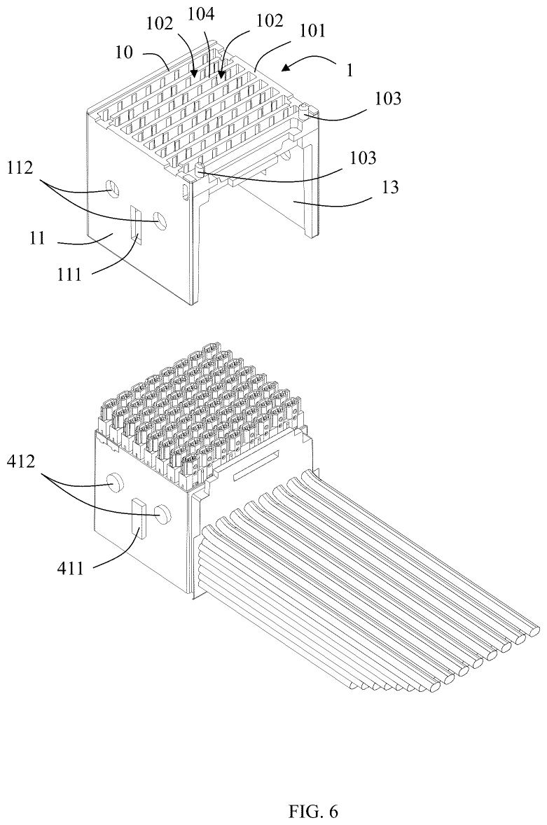

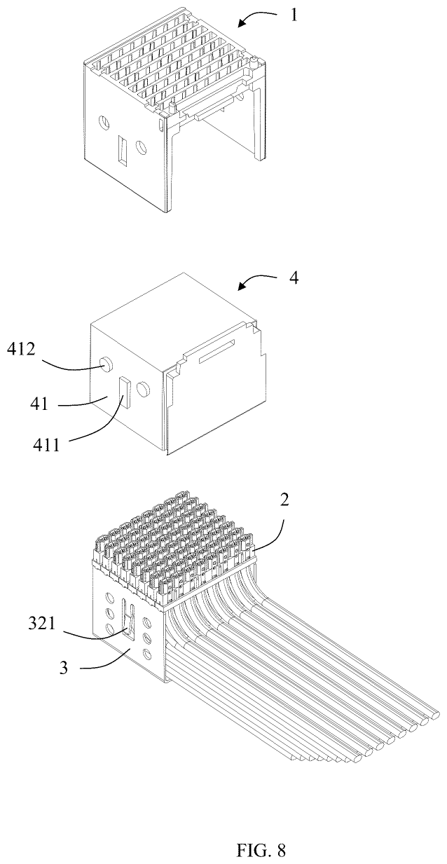

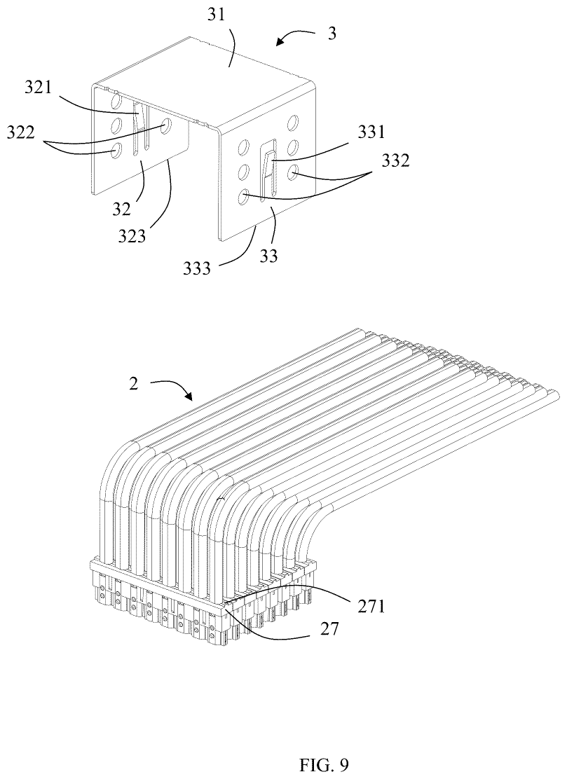

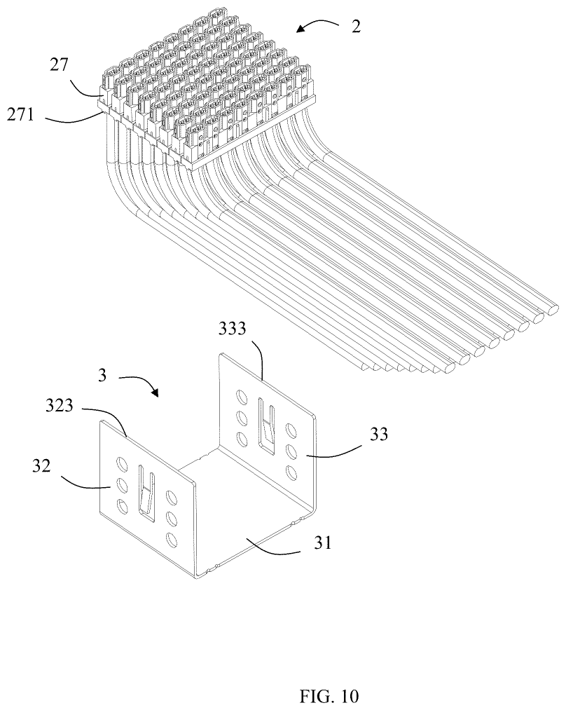

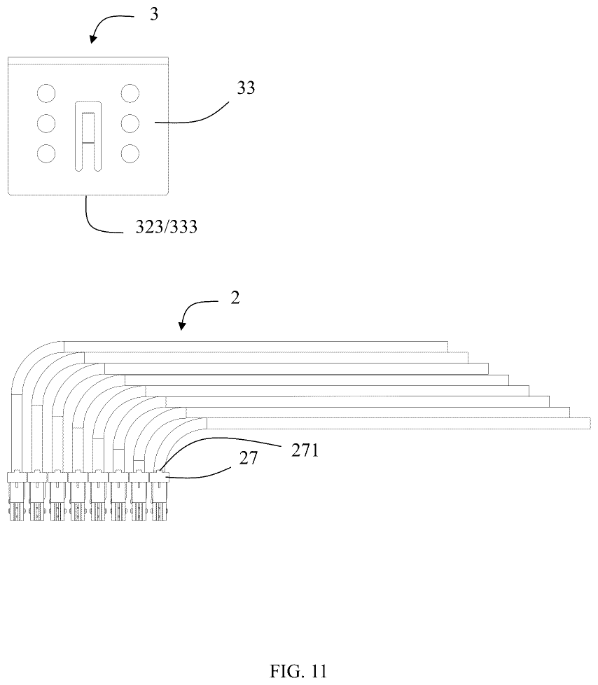

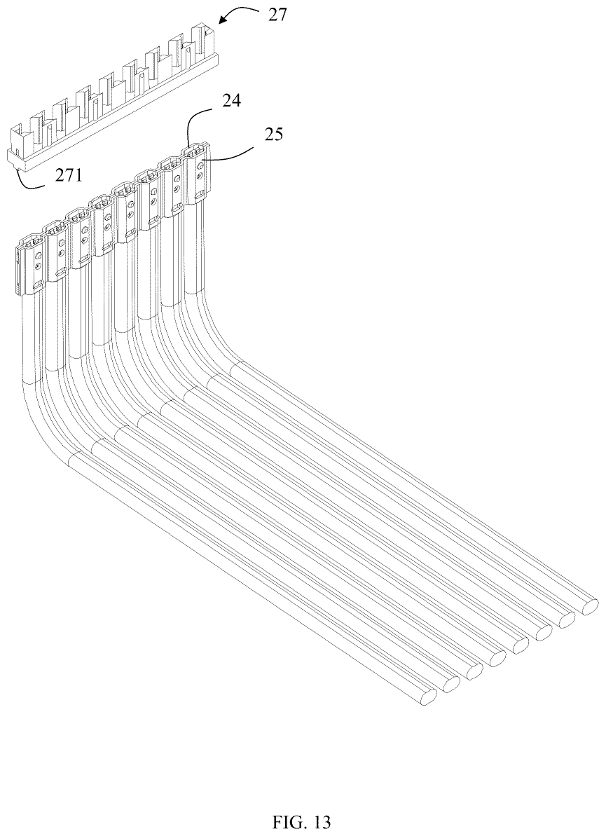

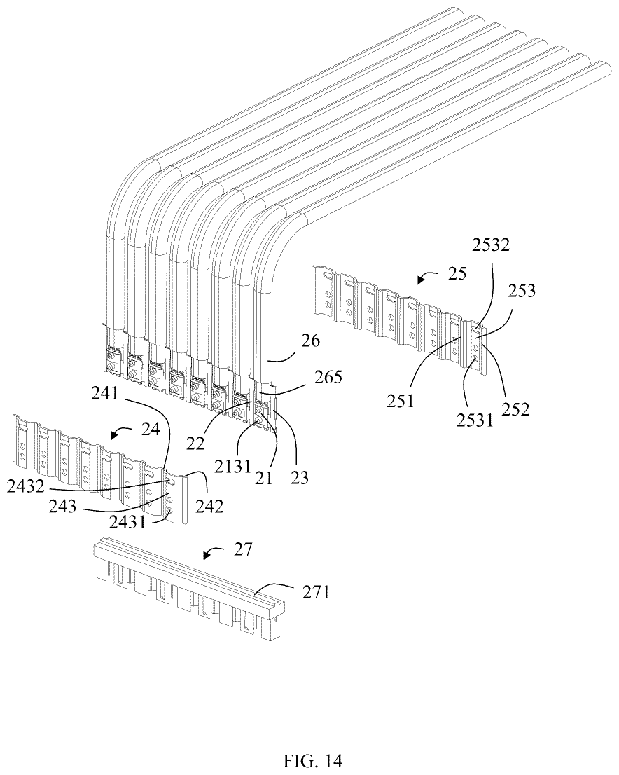

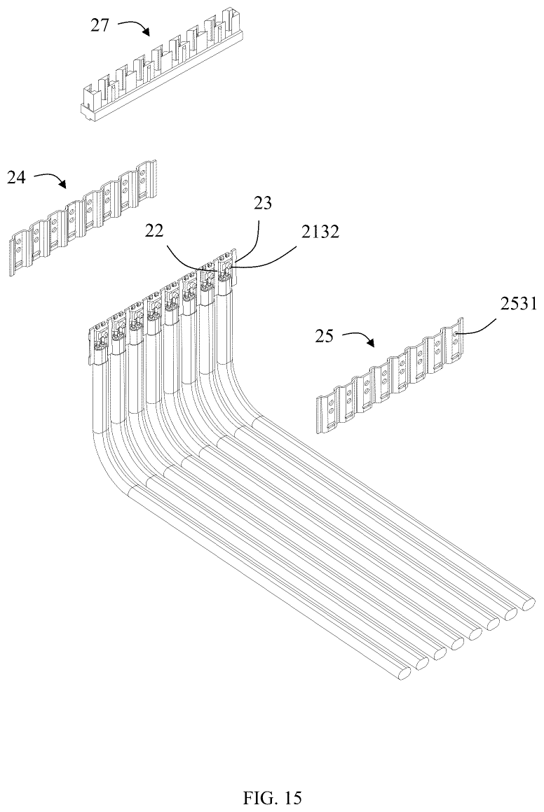

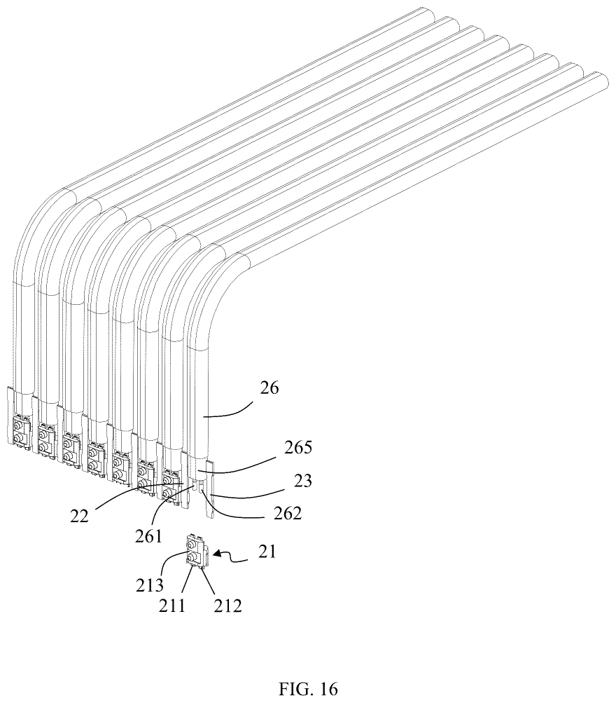

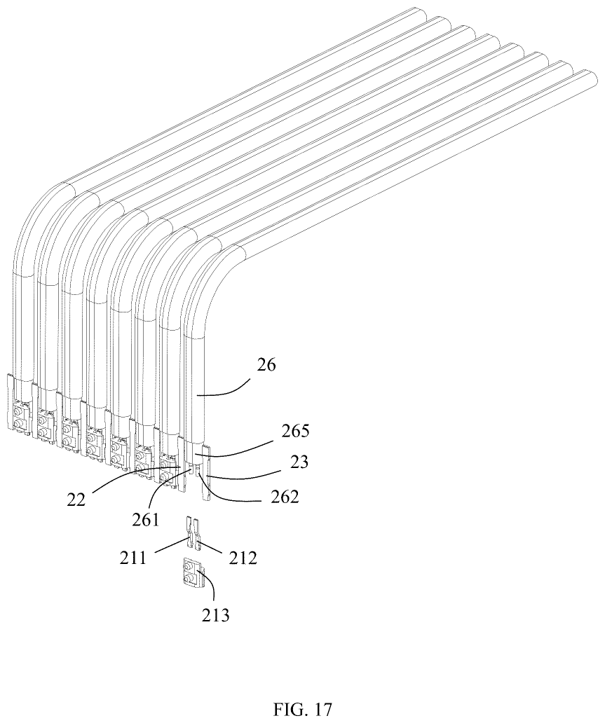

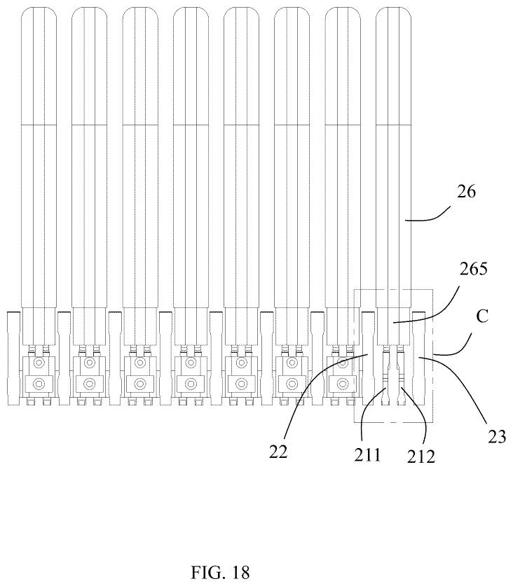

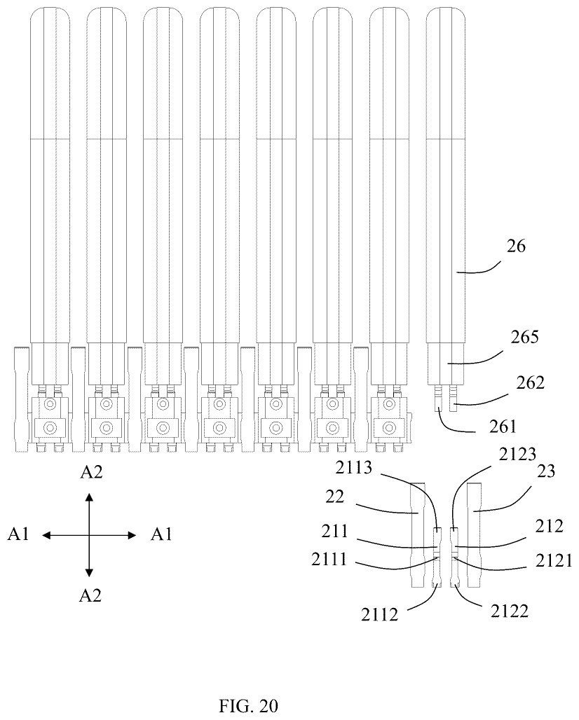

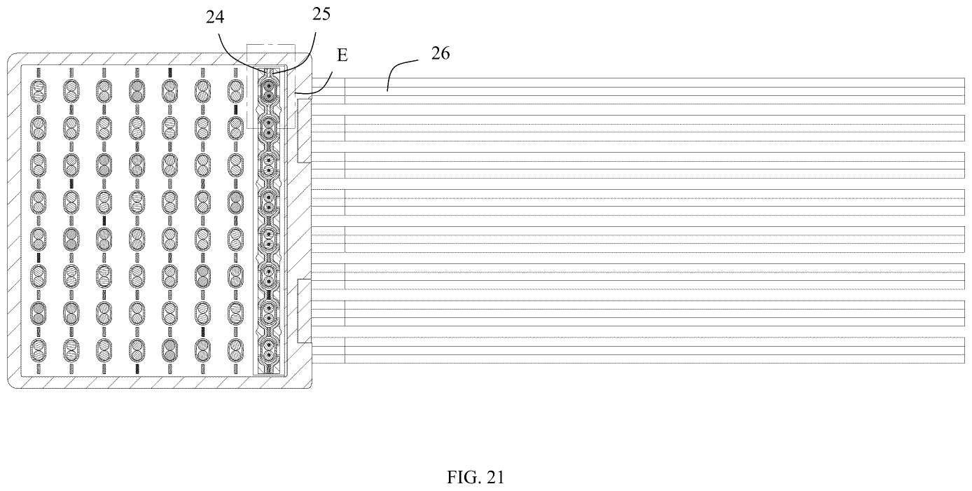

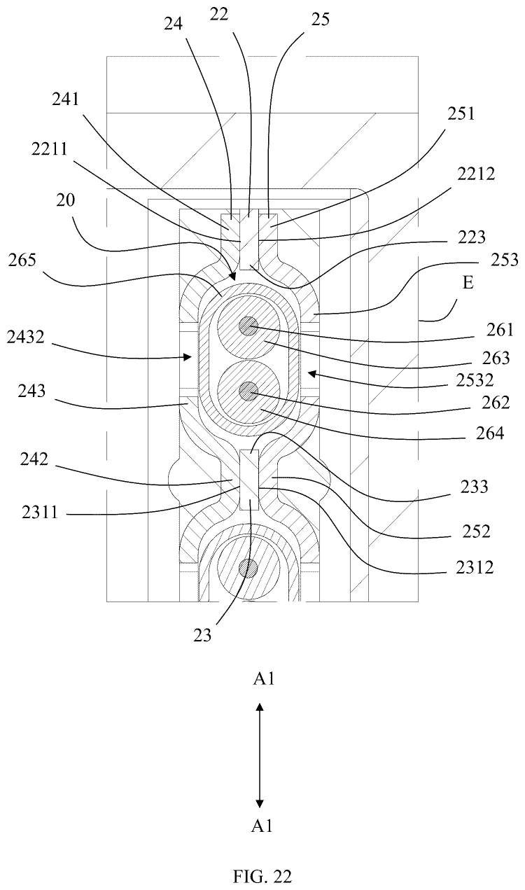

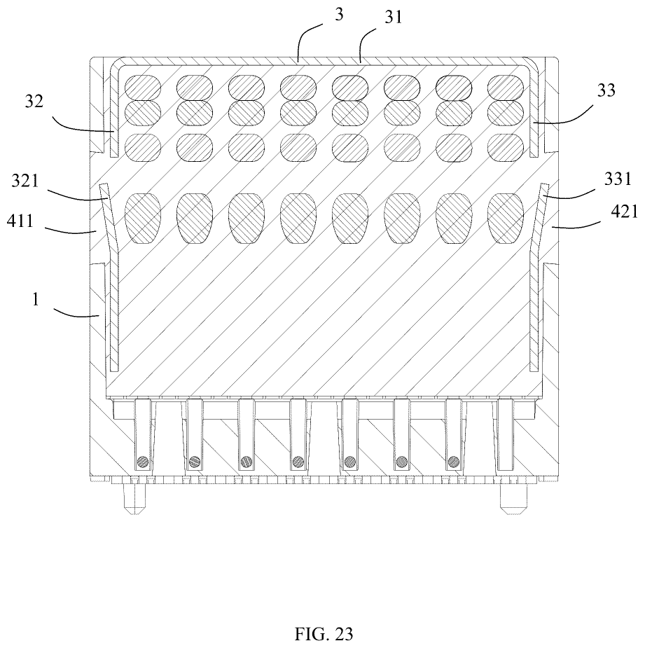

Referring to FIG. 1 to FIG. 23, the present disclosure discloses an electrical connector 100, which includes a body 1 and an installation module 2 mounted to the body 1. In the illustrated embodiment of the present disclosure, the electrical connector 100 is a backplane connector configured to electrically mate with a mating module (for example, a conductive film).

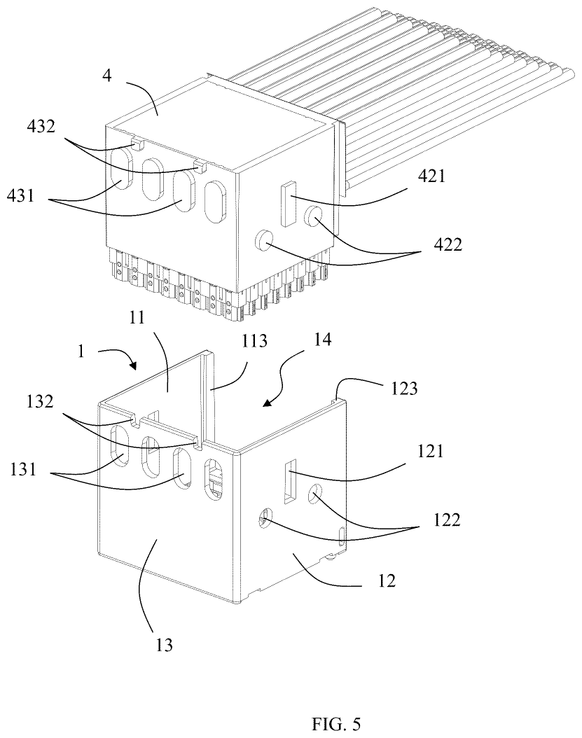

Referring to FIG. 5 to FIG. 8, in the illustrated embodiment of the present disclosure, the body 1 is a metal body to improve the shielding effect. The body 1 is generally of a frame shape, and includes a mounting wall 10, a first extension wall 11 connected to one side (for example, a left side) of the mounting wall 10, a second extension wall 12 connected to another side (for example, a right side) of the mounting wall 10, and a third extension wall 13 connected to one end (for example, a front end) of the mounting wall 10. The body 1 further defines an opening 14 opposite to the third extension wall 13.

In the illustrated embodiment of the present disclosure, the mounting wall 10 includes a mounting surface 101, a plurality of slots 102 extending through the mounting surface 101, and a plurality of positioning posts 103 protruding beyond the mounting surface 101. In the illustrated embodiment of the present disclosure, the plurality of slots 102 are arranged at intervals, in which any two adjacent slots 102 are separated by a partition wall 104 located between the two adjacent slots 102. It is understandable to those skilled in the art that in the illustrated embodiment of the present disclosure, the mounting surface 101 is a surface disposed facing the mating module when the electrical connector 100 is mated with the mating module.

The first extension wall 11 defines a first mounting slot 111 extending through the first extension wall 11 and a plurality of first positioning holes 112 extending through the first extension wall 11. In the illustrated embodiment of the present disclosure, the first mounting slot 111 is rectangular, and each first positioning hole 112 is a round hole. The first positioning holes 112 are located at a bottom of the first mounting slot 111 and disposed on two sides of the first mounting slot 111.

The second extension wall 12 defines a second mounting slot 121 extending through the second extension wall 12 and a plurality of second positioning holes 122 extending through the second extension wall 12. In the illustrated embodiment of the present disclosure, the second mounting slot 121 is rectangular, and each second positioning hole 122 is a round hole. The second positioning holes 122 are located at a bottom of the second mounting slot 121 and disposed on two sides of the second mounting slot 121.

Besides, an end of the first extension wall 11 away from the third extension wall 13 is further provided with a first extension rib 113 protruding toward the second extension wall 12. Similarly, an end of the second extension wall 12 away from the third extension wall 13 is further provided with a second extension rib 123 protruding toward the first extension wall 11. By providing the first extension rib 113 and the second extension rib 123, the installation module 2 can be prevented from being detached from the body 1.

In the illustrated embodiment of the present disclosure, the third extension wall 13 defines a plurality of third positioning holes 131 extending through the third extension wall 13 and a plurality of positioning grooves 132 extending upwardly through an upper edge of the third extension wall 13. In the illustrated embodiment of the present disclosure, each third positioning hole 131 is substantially elliptical. Of course, it is understandable to those skilled in the art that the size and shape of the first mounting slot 111, the second mounting slot 121, the first positioning hole 112, the second positioning hole 122 and the third positioning hole 131 can be flexibly adjusted as needed, which will not be described in detail in the present disclosure.

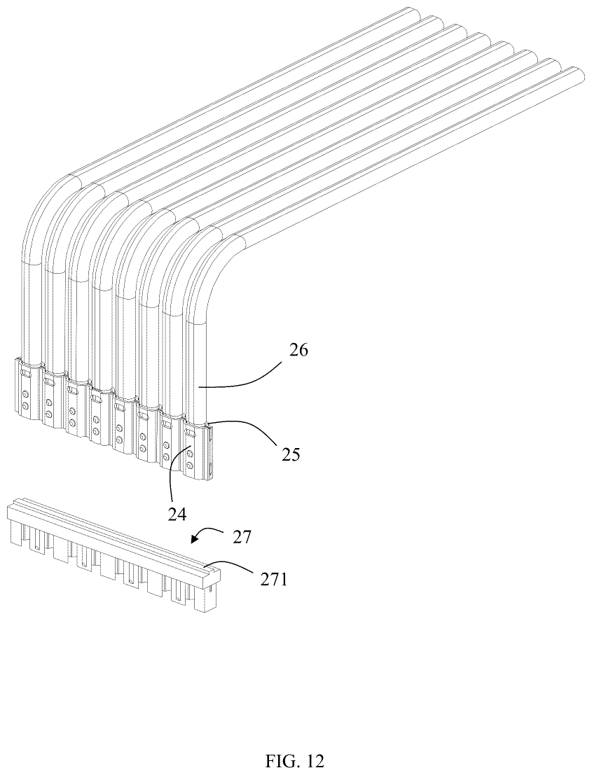

Referring to FIG. 12 to FIG. 22, the installation module 2 includes a plurality of terminal modules 21, a plurality of first ground terminals 22, a plurality of second ground terminals 23, a first metal shielding piece 24, a second metal shielding piece 25, a plurality of cables 26, and a second insulating block 27. In the illustrated embodiment of the present disclosure, the plurality of terminal modules 21 are arranged at intervals. Two sides of each terminal module 21 are associated with one first ground terminal 22 and one second ground terminal 23, respectively, to improve the shielding effect.

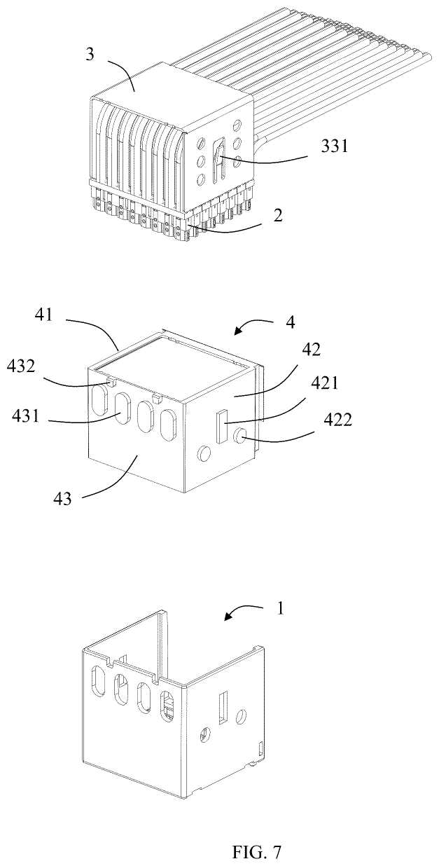

Referring to FIG. 7 to FIG. 11, in the illustrated embodiment of the present disclosure, the electrical connector 100 further includes a bracket 3 installed on the installation module 2 and a third insulating block 4 over-molded on the bracket 3 and the installation module 2.

In the illustrated embodiment of the present disclosure, the bracket 3 is made of metal material. The bracket 3 is generally U-shaped and includes a wall portion 31, a first side wall 32 bent from one end of the wall portion 31, and a second side wall 33 bent from another end of the wall portion 31.

The first side wall 32 is provided with a first protruding tab 321 and a plurality of first through holes 322 located on two sides of the first protruding tab 321. In the illustrated embodiment of the present disclosure, the first protruding tab 321 is integrally stamped outwardly from the first side wall 32. The first protruding tab 321 is cantilever-shaped, with one end being a free end and protruding outwardly from the first side wall 32. The first through holes 322 extend through the first side wall 32. The first side wall 32 includes a first abutting surface 323 at its bottom. In the illustrated embodiment of the present disclosure, the first abutting surface 323 is a flat surface.

Similarly, the second side wall 33 is provided with a second protruding tab 331 and a plurality of second through holes 332 located on two sides of the second protruding tab 331. In the illustrated embodiment of the present disclosure, the second protruding tab 331 is integrally stamped outwardly from the second side wall 33. The second protruding tab 331 is cantilever-shaped, with one end being a free end and protruding outwardly from the second side wall 33. The second through holes 332 extend through the second side wall 33. The second side wall 33 includes a second abutting surface 333 at its bottom. In the illustrated embodiment of the present disclosure, the second contact surface 333 is a flat surface. The first through holes 322 and the second through holes 332 are used to allow molten insulating material to pass through when over-molding the third insulating block 4 to facilitate molding the third insulating block 4.

The third insulating block 4 includes a first wall portion 41, a second wall portion 42 disposed opposite to the first wall portion 41, and a front wall portion 43 connecting the first wall portion 41 and the second wall portion 42. The first wall portion 41 is provided with a first mounting bump 411 and a plurality of first positioning bumps 412. The first protruding tab 321 corresponds to the first mounting bump 411 and is located inside the first mounting bump 411 to provide certain structural reinforcement to the first mounting bump 411. The first mounting bump 411 is fixed in the first mounting slot 111. The first positioning bumps 412 are fixed in the first positioning holes 112.

Similarly, the second wall portion 42 is provided with a second mounting bump 421 and a plurality of second positioning bumps 422. The second protruding tab 331 corresponds to the second mounting bump 421 and is located inside the second mounting bump 421 to provide certain structural reinforcement to the second mounting bump 421. The second mounting bump 421 is fixed in the second mounting slot 121. The second positioning bumps 422 are fixed in the second positioning holes 122. The first protruding tab 321 and the second protruding tab 331 are embedded in the third insulating block 4.

The front wall portion 43 is provided with a plurality of third positioning bumps 431 and a plurality of positioning protrusions 432. The third positioning bumps 431 are fixed in the third positioning holes 131. The positioning protrusions 432 are received in the positioning grooves 132 to achieve positioning and limiting.

In the illustrated embodiment of the present disclosure, the terminal module 21 includes a first signal terminal 211, a second signal terminal 212, and a first insulating block 213 fixed on the first signal terminal 211 and the second signal terminal 212. In an embodiment of the present disclosure, the first signal terminal 211 and the second signal terminal 212 are insert-molded with the first insulating block 213.

The first signal terminal 211 includes a first fixing portion 2111 fixed in the first insulating block 213, a first contact portion 2112 protruding beyond the first insulating block 213, and a first connection portion 2113. In the illustrated embodiment of the present disclosure, the first contact portion 2112 is an inelastic/stiff contact portion and is provided with a first contact surface 2112a located on its bottom surface.

Similarly, the second signal terminal 212 includes a second fixing portion 2121 fixed in the first insulating block 213, a second contact portion 2122 protruding beyond the first insulating block 213, and a second connection portion 2123. In the illustrated embodiment of the present disclosure, the second contact portion 2122 is an inelastic/stiff contact portion and is provided with a second contact surface 2122a located on its bottom surface. The first contact portion 2112 and the second contact portion 2122 both protrude downwardly beyond the first insulating block 213.

The first insulating block 213 is provided with a first positioning post 2131 and a second positioning post 2132. The first positioning post 2131 is configured to mate with the first metal shielding piece 24. The second positioning post 2132 is configured to mate with the second metal shielding piece 25.

The first ground terminal 22 is located on one side of the terminal module 21 along a first direction A1-A1 (for example, a left-right direction). The first ground terminal 22 is spaced apart from the first insulating block 213 along the first direction A1-A1. In other words, the first insulating block 213 does not cover the first ground terminal 22. The first ground terminal 22 includes a first main body portion 221 and a third contact portion 222. The first main body portion 221 is provided with a first side surface 2211 exposed to the first insulating block 213, and a third side surface 2212 disposed opposite to the first side surface 2211 and exposed to the first insulating block 213. The first main body portion 221 is entirely exposed to the first insulating block 213 along a second direction A2-A2 (for example, a top-bottom direction). In other words, the first main body portion 221 is not covered by the first insulating block 213 along the second direction A2-A2, so that the first main body portion 221 has more area to be in contact with the first metal shielding piece 24 and the second metal shielding piece 25. The second direction A2-A2 is perpendicular to the first direction A1-A1. In the illustrated embodiment of the present disclosure, the third contact portion 222 is an inelastic/stiff contact portion and is provided with a third contact surface 222a located on its bottom surface.

Similarly, the second ground terminal 23 is located on another side of the terminal module 21 along the first direction A1-A1. The second ground terminal 23 is spaced apart from the first insulating block 213 along the first direction A1-A1. In other words, the first insulating block 213 does not cover the second ground terminal 23. The second ground terminal 23 includes a second main body portion 231 and a fourth contact portion 232. The second main body portion 231 is provided with a second side surface 2311 exposed to the first insulating block 213, and a fourth side surface 2312 disposed opposite to the second side surface 2311 and exposed to the first insulating block 213. The second main body portion 231 is entirely exposed to the first insulating block 213 along the second direction A2-A2. In other words, the second main body portion 231 is not covered by the first insulating block 213 along the second direction A2-A2, so that the second main body portion 231 has more area to be in contact with the first metal shielding piece 24 and the second metal shielding piece 25. In the illustrated embodiment of the present disclosure, the fourth contact portion 232 is an inelastic/stiff contact portion and is provided with a fourth contact surface 232a located on its bottom surface.

The first metal shielding piece 24 is generally wave-shaped, and is provided with a first abutting portion 241, a second abutting portion 242, and a first raised portion 243 connecting the first abutting portion 241 and the second abutting portion 242. The first abutting portion 241 is in contact with the first side surface 2211 of the first ground terminal 22. The second abutting portion 242 is in contact with the second side surface 2311 of the second ground terminal 23. The first raised portion 243 is configured to at least partially accommodate the first insulating block 213. In one embodiment of the present disclosure, the first abutting portion 241 is fixed to the first side surface 2211 of the first ground terminal 22 by soldering or welding. The second abutting portion 242 is fixed to the second side surface 2311 of the second ground terminal 23 by soldering or welding. The first raised portion 243 defines a first positioning through hole 2431 that matches the first positioning post 2131.

Similarly, the second metal shielding piece 25 is generally wave-shaped and is provided with a third abutting portion 251, a fourth abutting portion 252, and a second raised portion 253 connecting the third abutting portion 251 and the fourth abutting portion 252. The third abutting portion 251 is in contact with the third side surface 2212 of the first ground terminal 22. The fourth abutting portion 252 is in contact with the fourth side surface 2312 of the second ground terminal 23. The second raised portion 253 is configured to at least partially accommodate the first insulating block 213. In one embodiment of the present disclosure, the third abutting portion 251 is fixed to the third side surface 2212 of the first ground terminal 22 by soldering or welding. The fourth abutting portion 252 is fixed to the fourth side surface 2312 of the second ground terminal 23 by soldering or welding. The second raised portion 253 defines a second positioning through hole 2531 that matches the second positioning post 2132.

The cable 26 includes a first core wire 261, a second core wire 262, a first insulation layer 263 wrapped around the first core wire 261, a second insulation layer 264 wrapped around the second core wire 262, and a ground shielding layer 265 located on an outer layer of the first insulation layer 263 and the second insulation layer 264.

The first core wire 261 is in contact with the first signal terminal 211. The second core wire 262 is in contact with the second signal terminal 212. The first metal shielding piece 24 and/or the second metal shielding piece 25 are in contact with the ground shielding layer 265 to improve the ground shielding effect.

In the illustrated embodiment of the present disclosure, the first raised portion 243 defines a first opening 2432 in which the ground shielding layer 265 is exposed. The second raised portion 253 defines a second opening 2532 in which the ground shielding layer 265 is exposed. In an embodiment of the present disclosure, by filling the first opening 2432 and the second opening 2532 with solder, the first raised portion 243 can be brought into contact with the ground shielding layer 265, and the second raised portion 253 can be brought into contact with the ground shielding layer 265.

In the illustrated embodiment of the present disclosure, the first abutting portion 241, the first raised portion 243, the second abutting portion 242, the second ground terminal 23, the fourth abutting portion 252, the second raised portion 253, the third abutting portion 251 and the first ground terminal 22 jointly form a shielding cavity 20. The first signal terminal 211 and the second signal terminal 212 are located in the shielding cavity 20, which is beneficial to improving the shielding effect and improving the quality of signal transmission.

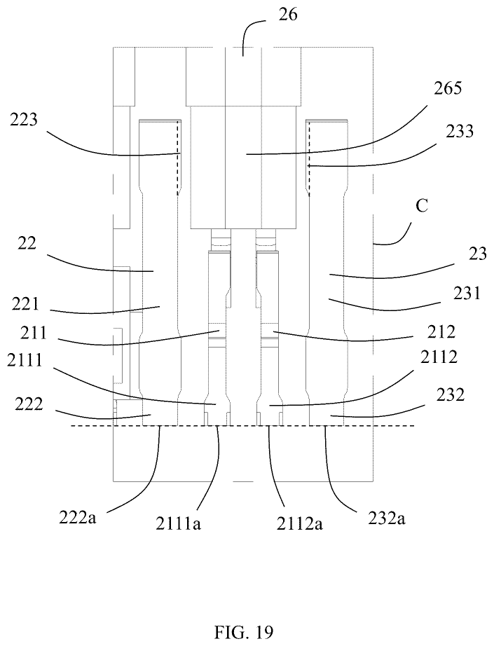

Referring to FIG. 19, in the illustrated embodiment of the present disclosure, the first ground terminal 22 includes a first protrusion 223 extending from the first main body portion 221 along the first direction A1-A1. The first protrusion 223 extends adjacent to the ground shielding layer 265 to reduce a gap with the ground shielding layer 265.

The second ground terminal 23 includes a second protrusion 233 extending from the second main body portion 231 along the first direction A1-A1. The second protrusion 233 extends adjacent to the ground shielding layer 265 to reduce a gap with the ground shielding layer 265. The first protrusion 223 and the second protrusion 233 protrude oppositely.

In the illustrated embodiment of the present disclosure, the first protrusion 223 and the second protrusion 233 at least partially protrude into the shielding cavity 20 along the first direction A1-A1.

In the illustrated embodiment of the present disclosure, the second insulating block 27 is at least partially molded on the first metal shielding piece 24, the second metal shielding piece 25, the first ground terminal 22, the third ground terminal 23 and the cable 26.

In the illustrated embodiment of the present disclosure, the second insulating block 27 does not reach a junction between the first core wire 261 and the first signal terminal 211, nor does it reach a junction of the second core wire 262 and the second signal terminal 212.

In the illustrated embodiment of the present disclosure, the second insulating block 27 does not reach the junction between the first core wire 261 and the first signal terminal 211, nor does it reach the junction of the second core wire 262 and the second signal terminal 212, under obstruction of the first protrusion 223 and the second protrusion 233. Such a setting is helpful for adjusting the impedance.

In the illustrated embodiment of the present disclosure, the second insulating block 27 includes a positioning rib 271. When the bracket 3 is installed on the installation module 2 and is installed in place, both the first abutting surface 323 and the second abutting surface 333 abut against the positioning rib 271, thereby ensuring the consistency of the position of the installation module 2 when the third insulating block 4 is molded.

In the illustrated embodiment of the present disclosure, the installation module 2 is assembled in a corresponding slot 102. The cables 26 extend from the opening 14 out of the body 1. In the illustrated embodiment of the present disclosure, the first contact surface 2112a, the second contact surface 2122a, the third contact surface 222a and the fourth contact surface 232a all protrude beyond the mounting surface 101. In the illustrated embodiment of the present disclosure, the first contact surface 2112a, the second contact surface 2122a, the third contact surface 222a and the fourth contact surface 232a are coplanar. Preferably, the first contact surface 2112a, the second contact surface 2122a, the third contact surface 222a, the fourth contact surface 232a, a bottom surface of the first metal shielding piece 24 and the bottom surface of the second metal shielding piece 25 are all coplanar.

Compared with the prior art, the electrical connector 100 of the present disclosure includes the first ground terminal 22, the second ground terminal 23, the first metal shielding piece 24 and the second metal shielding piece 25. The first ground terminal 22 is spaced apart from the first insulating block 213 along the first direction A1-A1. The second ground terminal 23 is spaced apart from the first insulating block 213 along the first direction A1-A1. With this arrangement, the first main body portion 221 of the first ground terminal 22 and the second main body portion 231 of the second ground terminal 23 are both exposed to the first insulating block 213. Therefore, the first metal shielding piece 24 and the second metal shielding piece 25 can be continuously in contact with the first main body portion 221 of the first ground terminal 22 and the second main body portion 231 of the second ground terminal 23 in the second direction A2-A2. This is beneficial to increasing the contact area with the first metal shielding piece 24 and the second metal shielding piece 25, and is beneficial to improving the anti-signal crosstalk performance.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a body, the body comprising a mounting surface; and
an installation module, the installation module being mounted to the body, the installation module comprising:
a terminal module, the terminal module comprising a first signal terminal, a second signal terminal, and a first insulating block disposed on the first signal terminal and the second signal terminal; the first signal terminal comprising a first fixing portion secured in the first insulating block and a first contact portion protruding beyond the first insulating block; the second signal terminal comprising a second fixing portion secured in the first insulating block and a second contact portion protruding beyond the first insulating block;
a first ground terminal, the first ground terminal being spaced apart from the first insulating block along a first direction; the first ground terminal comprising a first main body portion and a third contact portion; the first main body portion being exposed to the first insulating block along a second direction perpendicular to the first direction;
a second ground terminal, the second ground terminal being spaced apart from the first insulating block along the first direction; the second ground terminal comprising a second main body portion and a fourth contact portion; the second main body portion being exposed to the first insulating block along the second direction;
a first metal shielding piece, the first metal shielding piece comprising a first abutting portion, a second abutting portion, and a first raised portion connecting the first abutting portion and the second abutting portion; the first abutting portion being in contact with the first ground terminal; the second abutting portion being in contact with the second ground terminal; the first raised portion being configured to at least partially accommodate the first insulating block; and
a second metal shielding piece, the second metal shielding piece comprising a third abutting portion, a fourth abutting portion, and a second raised portion connecting the third abutting portion and the fourth abutting portion; the third abutting portion being in contact with the first ground terminal; the fourth abutting portion being in contact with the second ground terminal; the second raised portion being configured to at least partially accommodate the first insulating block;
wherein the first contact portion, the second contact portion, the third contact portion and the fourth contact portion all protrude beyond the mounting surface.

2. The electrical connector according to claim 1, wherein the first ground terminal is located on one side of the terminal module along the first direction, and the second ground terminal is located on another side of the terminal module along the first direction;
the first main body portion is entirely exposed to the first insulating block along the second direction; the first main body portion comprises a first side surface exposed to the first insulating block and a third side disposed opposite to the first side and exposed to the first insulating block;
the second main body portion is entirely exposed to the first insulating block along the second direction; the second main body portion comprises a second side surface exposed to the first insulating block and a fourth side disposed opposite to the second side and exposed to the first insulating block;
the first abutting portion is in contact with the first side surface of the first ground terminal, and the second abutting portion is in contact with the second side surface of the second ground terminal;
the third abutting portion is in contact with the third side surface of the first ground terminal, and the fourth abutting portion is in contact with the fourth side surface of the second ground terminal.

3. The electrical connector according to claim 1, wherein the installation module comprises a cable which comprises a first core wire, a second core wire, a first insulation layer wrapped around the first core wire, a second insulation layer wrapped around the second core wire, and a ground shielding layer located on an outer layer of the first insulation layer and the second insulation layer;
the first core wire is in contact with the first signal terminal; the second core wire is in contact with the second signal terminal; the first metal shielding piece and/or the second metal shielding piece are in contact with the ground shielding layer.

4. The electrical connector according to claim 3, wherein the first raised portion defines a first opening in which the ground shielding layer is at least partially exposed;
the second raised portion defines a second opening in which the ground shielding layer is at least partially exposed.

5. The electrical connector according to claim 3, wherein the first ground terminal comprises a first protrusion extending from the first main body portion along the first direction; the first protrusion extends adjacent to the ground shielding layer.

6. The electrical connector according to claim 5, wherein the second ground terminal comprises a second protrusion extending from the second main body portion along the first direction; the second protrusion extends adjacent to the ground shielding layer; the first protrusion and the second protrusion protrude oppositely.

7. The electrical connector according to claim 6, wherein the first abutting portion, the first raised portion, the second abutting portion, the second ground terminal, the fourth abutting portion, the second raised portion, the third abutting portion and the first ground terminal jointly form a shielding cavity in which the first signal terminal and the second signal terminal are located;
the first protrusion and the second protrusion at least partially protrude into the shielding cavity along the first direction.

8. The electrical connector according to claim 7, wherein the installation module comprises a second insulating block at least partially molded on the first metal shielding piece, the second metal shielding piece, the first ground terminal, the second ground terminal and the cable; the second insulating block does not reach a junction of the first core wire and the first signal terminal, nor does it reach a junction of the second core wire and the second signal terminal.

9. The electrical connector according to claim 8, wherein the second insulating block does not reach the junction of the first core wire and the first signal terminal, nor does it reach the junction of the second core wire and the second signal terminal, under obstruction of the first protrusion and the second protrusion.

10. The electrical connector according to claim 3, wherein the installation module comprises a second insulating block at least partially molded on the first metal shielding piece, the second metal shielding piece, the first ground terminal, the second ground terminal and the cable; the second insulating block is provided with a positioning rib;
the electrical connector further comprises a bracket mounted on the installation module; the bracket is provided with an abutting surface that abuts against the positioning rib.

11. The electrical connector according to claim 10, wherein the bracket comprises a wall portion, a first side wall bent from one end of the wall portion, and a second side wall bent from another end of the wall portion; the first side wall is provided with a first protruding tab; the second side wall is provided with a second protruding tab;
the electrical connector further comprises a third insulating block over-molded on the bracket and the installation module; the first protruding tab and the second protruding tab are embedded in the third insulating block.

12. The electrical connector according to claim 11, wherein the third insulating block is provided with a first mounting bump and a second mounting bump; the first protruding tab corresponds to the first mounting bump and is located inside the first mounting bump; the second protruding tab corresponds to the second mounting bump and is located inside the second mounting bump;
the body defines a first mounting slot and a second mounting slot; the first mounting bump is secured in the first mounting slot; the second mounting bump is secured in the second mounting slot.

13. The electrical connector according to claim 11, wherein the body is a metal body; the body comprises a mounting wall, a first extension wall connected to one side of the mounting wall, a second extension wall connected to another side of the mounting wall, and a third extension wall connected to one end of the mounting wall;
the mounting surface is provided on the mounting wall;
the first extension wall defines a first positioning hole; the second extension wall defines a second positioning hole; the third extension wall defines a third positioning hole;
the third insulating block is provided with a first positioning bump secured in the first positioning hole, a second positioning bump secured in the second positioning hole, and a third positioning bump secured in the third positioning hole.

14. The electrical connector according to claim 1, wherein the first contact portion, the second contact portion, the third contact portion, and the fourth contact portion are all non-elastic contact portions.

15. The electrical connector according to claim 14, wherein the first contact portion is provided with a first contact surface; the second contact portion is provided with a second contact surface; the third contact portion is provided with a third contact surface; the fourth contact portion is provided with a fourth contact surface; the first contact surface, the second contact surface, the third contact surface and the fourth contact surface are coplanar.

16. An electrical connector, comprising:
a body, the body comprising a mounting surface; and
an installation module, the installation module being mounted to the body, the installation module comprising:
a plurality of terminal modules, the plurality of terminal modules being disposed at intervals along a first direction; each terminal module comprising a first signal terminal, a second signal terminal, and a first insulating block fixed on the first signal terminal and the second signal terminal; the first signal terminal comprising a first contact portion; the second signal terminal comprising a second contact portion;
a plurality of first ground terminals, each first ground terminal comprising a first main body portion and a third contact portion;
a plurality of second ground terminals, each second ground terminal comprising a second main body portion and a fourth contact portion;
a first metal shielding piece, the first metal shielding piece comprising a first abutting portion, a second abutting portion, and a first raised portion connecting the first abutting portion and the second abutting portion; the first abutting portion being in contact with the first ground terminal; the second abutting portion being in contact with the second ground terminal; and
a second metal shielding piece, the second metal shielding piece comprising a third abutting portion, a fourth abutting portion, and a second raised portion connecting the third abutting portion and the fourth abutting portion; the third abutting portion being in contact with the first ground terminal; the fourth abutting portion being in contact with the second ground terminal; the first insulating block being clamped by the first raised portion and the second raised portion;
wherein two sides of each terminal module along the first direction are associated with one first ground terminal and one second ground terminal; none of the first ground terminal and the second ground terminal is covered by the first insulating block; the first main body portion of the first ground terminal is exposed to the first insulating block along a second direction perpendicular to the first direction, so that the first abutting portion and the third abutting portion are in continuous contact with two opposite sides of the first main body portion, respectively, along the second direction; the second main body portion of the second ground terminal is exposed to the first insulating block along the second direction, so that the second abutting portion and the fourth abutting portion are in continuous contact with two opposite sides of the second main body portion, respectively, along the second direction;
wherein the first contact portion, the second contact portion, the third contact portion and the fourth contact portion all protrude beyond the mounting surface.

17. The electrical connector according to claim 16, wherein the first main body portion is entirely exposed to the first insulating block along the second direction; the first main body portion comprises a first side surface exposed to the first insulating block and a third side disposed opposite to the first side and exposed to the first insulating block;
the second main body portion is entirely exposed to the first insulating block along the second direction; the second main body portion comprises a second side surface exposed to the first insulating block and a fourth side disposed opposite to the second side and exposed to the first insulating block;
the first abutting portion is in contact with the first side surface of the first ground terminal, and the second abutting portion is in contact with the second side surface of the second ground terminal;
the third abutting portion is in contact with the third side surface of the first ground terminal, and the fourth abutting portion is in contact with the fourth side surface of the second ground terminal.

18. The electrical connector according to claim 16, wherein the installation module comprises a plurality of cables each comprising a first core wire, a second core wire, a first insulation layer wrapped around the first core wire, a second insulation layer wrapped around the second core wire, and a ground shielding layer located on an outer layer of the first insulation layer and the second insulation layer;
the first core wire is in contact with the first signal terminal; the second core wire is in contact with the second signal terminal; the first metal shielding piece and/or the second metal shielding piece are in contact with the ground shielding layer.

19. The electrical connector according to claim 18, wherein the first ground terminal comprises a first protrusion extending from the first main body portion along the first direction; the first protrusion extends adjacent to the ground shielding layer;
wherein the second ground terminal comprises a second protrusion extending from the second main body portion along the first direction; the second protrusion extends adjacent to the ground shielding layer; the first protrusion and the second protrusion protrude oppositely.

20. The electrical connector according to claim 19, wherein the first abutting portion, the first raised portion, the second abutting portion, the second ground terminal, the fourth abutting portion, the second raised portion, the third abutting portion and the first ground terminal jointly form a shielding cavity in which the first signal terminal and the second signal terminal are located;
the first protrusion and the second protrusion at least partially protrude into the shielding cavity along the first direction;
the second insulating block does not reach a junction of the first core wire and the first signal terminal, nor does it reach a junction of the second core wire and the second signal terminal, under obstruction of the first protrusion and the second protrusion.
